(19) United States
(12) Patent Application Publication
(10) Pub. No.: US 2011/0170419 A1
(43) Pub. Date: Jul. 14, 2011

(54) MICROWAVE DEVICE, SYSTEM AND METHOD FOR INSTRUCTING ACM SWITCHING IN HSM SYSTEMS

(76) Inventors: Xuekun Zhang, Shenzhen (CN); Bangmei Deng, Shenzhen (CN); Rui Chen, Shenzhen (CN)

(21) Appl. No.: 12/985,791

(22) Filed: Jan. 6, 2011

(30) Foreign Application Priority Data
Jan. 13, 2010 (CN) 201010001235.4

(51) Int. Cl. H04L 12/56; H04L 12/26

(52) U.S. Cl. 370/241; 370/389

(57) ABSTRACT

A method for instructing an Adaptive Code and Modulation (ACM) switching is provided, which is applied in a microwave communication system configured with an ACM function and a Hitless Switch Mode (HSM) function. The method includes: obtaining signal quality of an active link and signal quality of a standby link; generating an ACM switching instruction according to the better one between the signal quality of the active link and the signal quality of the standby link; and transmitting the ACM switching instruction to a transmitting device of the active link. A device and a system are also provided. Through the method, device and system, the available bandwidth of a link is fully utilized when the signal quality of the standby link is better than the signal quality of the active link.

### CROSS-REFERENCE TO RELATED APPLICATION

This application claims priority to Chinese Patent Application No. 201010001235.4, filed on Jan. 13, 2010, which is hereby incorporated by reference in its entirety.

### FIELD OF THE INVENTION

The present invention relates to the field of communication technologies, and in particular, to a microwave device, a system, and a method for instructing an Adaptive Code and Modulation (ACM) switching in HSM systems.

### BACKGROUND OF THE INVENTION

A microwave communication system in the prior art has the function of changing and adjusting the coding manner and the modulation mode of the system in real time according to the channel quality, that is, a microwave communication system in the prior art has the function of Adaptive Code and Modulation (ACM). A receiving device obtains the quality of signals transmitted in the air space. If the quality of signals transmitted in air space obtained this time is above the good threshold or below the bad threshold, an ACM switching instruction is generated, which includes the coding manner and modulation mode corresponding to the quality of signals transmitted in air space obtained this time. Then, the receiving device feeds the switching instruction back to the transmitting device through a feedback channel, and then the transmitting device performs an ACM switching on the data according to the switching instruction. That is to say, the modulation mode and coding manner of the link are changed to the modulation mode and the coding manner including in the switching instruction, and data rate now is changed to the data rate which is determined by the modulation mode and the coding manner in the switching instruction, thus realizing a compromise between reliabity and efficiency of the system.

In a microwave communication system, since the response of channel of an air link changes rapidly with time and environment, in order to guarantee that user's data are transmitted reliably, the microwave communication system generally applies a Hitless Switching Mode (HSM) protection manner to protect the user's data. In the HSM protection manner, the same data may be transmitted in different route using the same frequency (space diversity) or using different frequencies (frequency diversity). Two Receivers receiving the same user data from different ways compare the quality of the data and selects data with better quality from the two discard the others.

The ACM function realizes link protection and the HSM function realizes service data protection, and using the ACM function in conjunction with the HSM function can effectively improve the transmission efficiency and the transmission reliability of the microwave system.

In the prior art, when a microwave communication system is configured with an ACM function and an HSM function at the same time, the ACM engine of the protected link is closed all the time and the ACM engine of an active link is open all the time. The receiving device of the active link obtains signal quality of the active link, and generates an ACM switching instruction according to the signal quality of the active link, that is, the ACM switching instruction is generated if the signal quality of the active link obtained this time is different from the signal quality of the active link obtained last time, where the switching instruction includes the coding manner and modulation mode corresponding to the signal quality of the active link obtained this time. Then, the receiving device of the active link transmits the ACM switching instruction to the transmitting device of the active link. After the transmitting device of the active link receives the ACM switching instruction, the transmitting device performs an ACM switching according to the ACM switching instruction, which includes the following steps. The transmitting device of the active link switches the user's data rate according to the ACM switching instruction, transmits the users data and the ACM switching instruction to the transmitting device of the standby link (hot standby protected link), thereby ensuring the consistency of the user's data rate and space bandwidth of the active link and the standby link. Besides, the transmitting device of the standby link switches the coding manner and the modulation mode following the transmitting device of the active link according to the ACM switching instruction.

During the research and implementation of the prior art, the inventor of the present invention finds that, in a microwave communication system configured with an ACM function and an HSM function, since the space bandwidth of the system is determined by the coding manner and modulation mode in an ACM switching instruction, and the ACM switching instruction is generated according to the signal quality of the active link, the bandwidth of the system is determined by the signal quality of the active link. Thereby, when the signal quality of a standby link is better than the signal quality of an active link, the available bandwidth of the links cannot be fully utilized, and thus the transmission efficiency of the system is relatively low.

### SUMMARY OF THE INVENTION

A method for instructing an ACM switching is provided, where the method includes:

obtaining signal quality of an active link and signal quality of a standby link;

generating an ACM switching instruction according to the better one between the signal quality of the active link and the signal quality of the standby link; and

transmitting the ACM switching instruction to a transmitting device, so as to instruct the transmitting device to perform an ACM switching.

A microwave device is provided, where the device includes:

an obtaining module, configured to obtain signal quality of an active link and the signal quality of a standby link;

a generating module, configured to generate an ACM switching instruction according to the better one between the signal quality of the active link and the signal quality of the standby link; and

a first transmitting module, configured to transmit the ACM switching instruction to a transmitting device, so as to instruct the transmitting device to perform an ACM switching.

A microwave communication system is provided, where the system includes:

a receiving device, configured to obtain the signal quality of an active link and the signal quality of a standby link, generate an ACM switching instruction according to the better one between the signal quality of the active link and the signal quality of the standby link, and transmit the generated ACM switching instruction to a transmitting device, so as to instruct the transmitting device to perform an ACM switching; and

a transmitting device, configured to receive the ACM switching instruction from the receiving device, and perform an ACM switching on the data rate according to the ACM switching instruction.

### DETAILED DESCRIPTION OF THE DRAWINGS

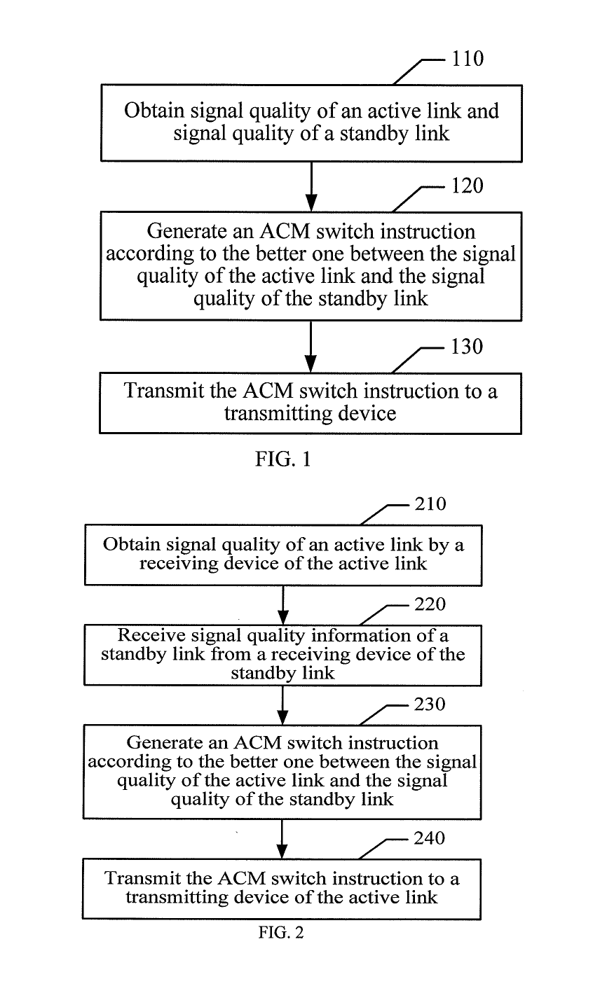

FIG. 1 is a schematic view of a method for instructing an ACM switching according to embodiments of the present invention;

FIG. 2 is another schematic view of a method for instructing an ACM switching according to embodiments of the present invention;

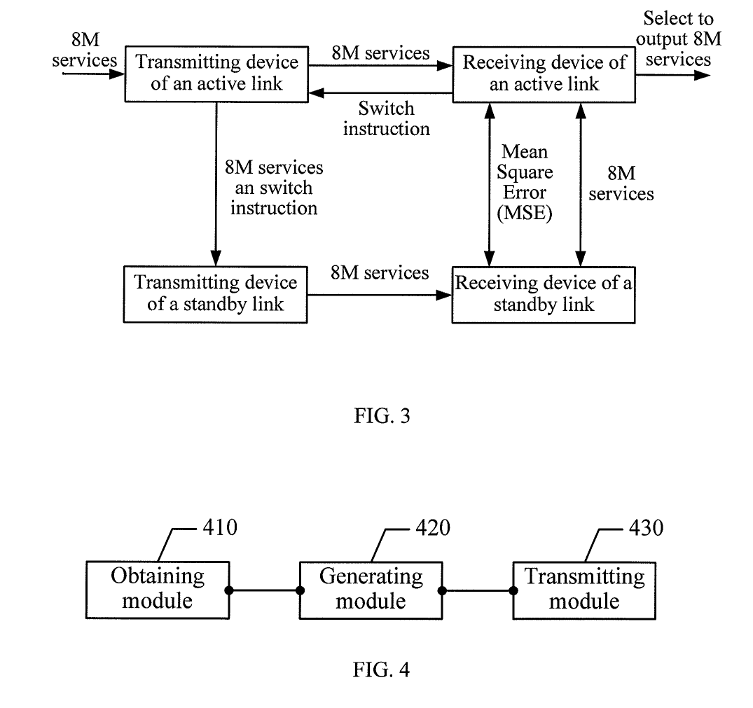

FIG. 3 is a schematic view of a specific application scene of the embodiment shown in FIG. 2;

FIG. 4 is a schematic view of a device for instructing an ACM switching according to embodiments of the present invention;

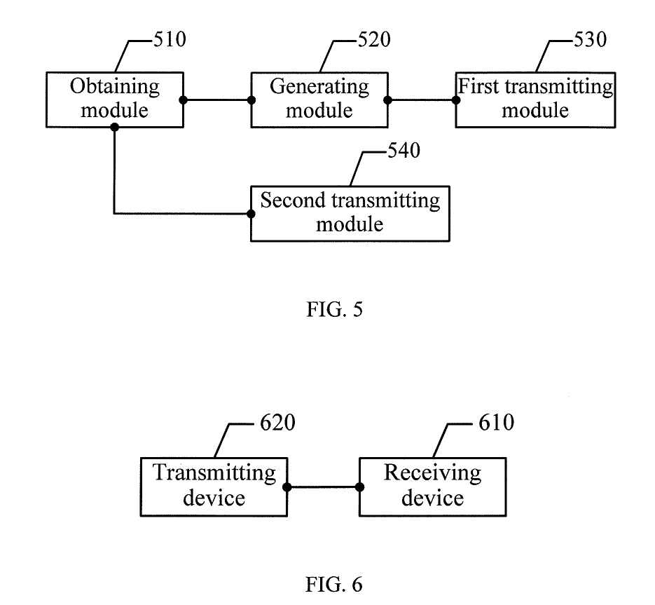

FIG. 5 is a schematic view of a microwave device according to embodiments of the present invention; and

FIG. 6 is a schematic view of a microwave communication system according to embodiments of the present invention.

### DETAILED DESCRIPTION OF THE EMBODIMENTS

The embodiments of the present invention provide a microwave device, a system, and a method for instructing an ACM switching, which are illustrated respectively in detail in the following.

In an embodiment of the present invention, a method for instructing an ACM switching is applied in a microwave communication system configured with an ACM function and an HSM function. Referring to FIG. 1, the method for instructing an ACM switching according to an embodiment of the present invention includes the following steps.

In step 110, signal quality of an active link and signal quality of a standby link are obtained.

In this embodiment, the step may be implemented by a receiving device of the active link, or a receiving device of the standby link, or by a newly added ACM switching instruction device which is not a receiving device.

The signal quality of the active link and the signal quality of the standby link may be obtained through a detecting mechanism of a receiving end.

In step 120, an ACM switching instruction is generated according to the better one between the signal quality of the active link and the signal quality of the standby link.

The difference of the step for generating the ACM switching instruction in the embodiment and that in the prior art is as follows. In the prior art, the signal quality of an active link is used to generate the ACM switching instruction. However, in the embodiment, the better one between the signal quality of an active link and the signal quality of a standby link is used to generate the ACM switching instruction.

Specifically, step 120 may include: judging whether the better one between the signal quality of the active link and the signal quality of the standby link obtained this time is the same as the better one between the signal quality of the active link and the signal quality of the standby link obtained last time; and generating the ACM switching instruction if they are different. The switching instruction includes a coding manner and a modulation mode corresponding to the better one between the signal quality of the active link and the signal quality of the standby link obtained this time.

In step 130, the ACM switching instruction is transmitted to a transmitting device so as to instruct the transmitting device to perform an ACM switching.

After the ACM switching instruction is generated, the ACM switching instruction may be transmitted to the transmitting device of the active link so that the transmitting devices of the active link and the standby link perform an ACM switching according to the ACM switching instruction. That is to say, a coding manner and a modulation mode are changed to the coding manner and the modulation mode in the switching instruction, and the user's data rate is changed to the data rate which is determined by the coding manner and the modulation mode in the switching instruction.

It can be understood that, the ACM switching instruction may also be transmitted to a transmitting device of the standby link, thus enabling the transmitting device of the standby link to perform an ACM switching according to the instruction.

When the embodiment is implemented by the receiving device of the standby link, the ACM switching instruction may be transmitted to the transmitting device of the active link through the receiving device of the active link, or the ACM switching instruction may be transmitted to the transmitting device of the active link by a set-up direct channel.

In this embodiment, an ACM switching indication is generated according to the better one between the signal quality of the active link and the signal quality of the standby link, so the bandwidth of the system is determined by the better one between the signal quality of the active link and the signal quality of the standby link. Therefore, when the signal quality of the standby link is better than the signal quality of the active link, the space bandwidth of the system is determined by the better signal quality of the standby link. Compared with the determining by the poor signal quality of the active link in the prior art, the embodiment can fully utilize the available bandwidth of the link, thus improving the transmission efficiency of the system. It can be understood that, in the HSM protection manner, the active link and the standby link use a dual transmission mode in order that a better one is easy to be selected from the two redundant links. In fact, any one of the two redundant links may be treated as an active link, that is, the two links may be seen as a standby link for each other. In the embodiments of the present invention, the term “active link” and “standby link” are merely for facilitating those skilled in the art to understand the technical solution more easily, which is not intended to limit the present invention. Further, in the HSM protection manner, more redundant links may be used to transmit service data, thus realizing the multi-transmission of the data. A method for instructing an ACM switching by using more than three links is similar to the method through two links, which is not described in detail herein.

Referring to FIG. 2, a method for instructing an ACM switching according to another embodiment of the present invention includes the following steps.

In step 210, signal quality of an active link is obtained by a receiving device of the active link.

The embodiment may be implemented by an ACM engine in a receiving device of the active link, so as to reduce the modifications to the prior art. The ACM engine may obtain the signal quality of the active link through the detecting mechanism of the receiving device of the active link.

The signal quality of the active link may be a Mean Square Error (MSE) between an actual signal and a standard signal of the active link.

In step 220, signal quality information of a standby link is received by the receiving device of the active link from a receiving device of the standby link.

The ACM engine in the receiving device of the standby link may obtain the signal quality of the standby link through the detecting mechanism of the receiving device of the standby link. The signal quality information of the standby link is received by the receiving device of the active link from the receiving device of the standby link through a connected hardware or a software protocol, where receiving the signal quality information of the standby link through the hardware better meets the real-time requirement of an ACM switching.

The signal quality of the standby link may be the MSE between the actual signal and the standard signal of the standby link (the term “MSE between the actual signal and the standard signal” is referred to as “MSE” for short hereinafter).

In step 230, an ACM switching instruction is generated by the receiving device of the active link according to the better one between the signal quality of the active link and the signal quality of the standby link.

For the implementation of step 230, reference can be made to the description of step 120.

In step 240, the ACM switching instruction is transmitted by the receiving device of the active link to a transmitting device of the active link, so as to instruct the transmitting device to perform an ACM switching.

After the ACM switching instruction is generated, the ACM switching instruction is transmitted by the receiving device of the active link to the transmitting device of the active link through an ACM feedback channel.

It should be noted that, the receiving device of the active link may transmit the signal quality information of the active link to the receiving device of the standby device, so as to ensure the consistency of the data of the active link and the standby link.

To facilitate understanding, a specific application scene of an embodiment shown in FIG. 2 is described in detail in the following. Referring to FIG. 3, a schematic view of a specific application scene of the embodiment shown in FIG. 2 is shown.

As shown in FIG. 3, the receiving device of the active link and the one of the standby link transmit an MSE information of each link to each other respectively through hardware. After obtaining the MSE of the active link, and receiving the MSE information of the standby link from the receiving device of the standby link, the receiving device of the active link judges whether the better one between the MSE of the active link and the MSE of the standby link obtained this time is the same as the better one between the MSE of the active link and the MSE of the standby link obtained last time. If they are different, the receiving device of the active link generates an ACM switching instruction, and transmits the ACM switching instruction to a transmitting device of the active link through a feedback channel, where the switching instruction includes a coding manner and a modulation mode corresponding to the better one between the MSE of the active link and the MSE of the standby link obtained this time.

A multiplexing unit of the transmitting device of the active link (not shown in the Figure) changes the space bandwidth according to the coding manner and the modulation mode in the ACM switching instruction, transmits the service data after changing the space bandwidth and transmits the ACM switching instruction to an intermediate frequency unit (not shown in the Figure) of the transmitting device of the active link and a multiplexing unit (not shown in the Figure) of the transmitting device of the standby link. Then, the intermediate frequency units of the transmitting devices of the active link and the standby link perform the switching of a coding manner and a modulation mode to the data rate according to the coding manner and the modulation mode in the ACM switching instruction, and then transmit the switched service data to the receiving devices of the active link and the standby link respectively.

At the same time, in order to realize an HSM function, the receiving devices of the active link and the standby link transmit the service data to each other at the receiving end, and the receiving device of the active link selects a service with better quality from the two services to output.

Supposing that the service bandwidth of the active link and the standby link is 4M at the beginning, if the link environment changes and thus the MSE of the standby link is better than the MSE of the active link, for example, the active link can output the service data with 2M service bandwidth, while the standby link can output the service data with 8 M service bandwidth, the receiving device of the active link generates an ACM switching instruction according to the MSE of the standby link, so that the service bandwidth of the system is switched to 8M. However, in the prior art, the receiving device of the active link generates an ACM switching instruction merely according to the MSE of the active link, so that the service bandwidth of the system is switched to 2M.

This embodiment has the same beneficial effects as the embodiment shown in FIG. 1, and the embodiment is implemented by the receiving device of the active link, which can reduce the modifications to the prior art.

A device for instructing an ACM switching according to embodiments of the present invention is described in detail in the following. Referring to FIG. 4, a device for instructing an ACM switching according to an embodiment of the present invention includes:

an obtaining module 410, configured to obtain signal quality of an active link and signal quality of a standby link;

a generating module 420, configured to generate an ACM switching instruction according to the better one between the signal quality of the active link and the signal quality of the standby link; and

a transmitting module 430, configured to transmit the ACM switching instruction to a transmitting device, so as to instruct the transmitting device to perform an ACM switching.

The device for instructing an ACM switching is applied in a microwave communication system configured with an ACM function and an HSM function, and may be installed in a receiving device of the active link of the system, or in a receiving device of the standby link of the system, or in a newly added device which is independent of the receiving device in the system.

The obtaining module 410 may obtain the signal quality of the active link and the standby link by detecting the active link and the standby link. Because the receiving device can obtain the signal quality of its link through a detecting mechanism of the receiving device, if the device corresponding to FIG. 4 is installed in the receiving device of the active link of the system, the obtaining module 410 may obtain the signal quality of the active link through the detecting mechanism, or may obtain the signal quality of the standby link through the receiving device of the standby link. Likewise, if the device corresponding to FIG. 4 is installed in the receiving device of the standby link of the system, the obtaining module 410 may obtain the signal quality of the standby link through the detecting mechanism, or may obtain the signal quality of the active link through the receiving device of the active link.

The generating module 420 judges whether the better one between the signal quality of the active link and the signal quality of the standby link obtained this time is the same as the better one between the signal quality of the active link and the signal quality of the standby link obtained last time, and generates an ACM switching instruction if they are different, where the ACM switching instruction includes a coding manner and a modulation mode corresponding to the better one between the signal quality of the active link and the signal quality of the standby link obtained this time.

The transmitting module 430 may transmit the ACM switching instruction generated by the generating module 420 to a transmitting device of the active link, thus enabling the transmitting device to perform an ACM switching according to the ACM switching instruction.

In this embodiment, the ACM switching instruction is generated according to the better one between the signal quality of the active link and the signal quality of the standby link, so the service bandwidth of the system is determined by the better one between the signal quality of the active link and the signal quality of the standby link. Therefore, when the signal quality of the standby link is better than the signal quality of the active link, the service bandwidth of the system is determined by the better signal quality of the standby link. Compared with the determining by the poor signal quality of the active link in the prior art, the embodiment can fully utilize the available bandwidth of the link, thus improving the transmission efficiency of the system.

A microwave device according to the embodiments of the present invention is described in detail in the following. Referring to FIG. 5, an embodiment of a microwave device of the present invention includes:

an obtaining unit 510, configured to obtain the signal quality of an active link and the signal quality of a standby link;

a generating module 520, configured to generate an ACM switching instruction according to the better one between the signal quality of the active link and the signal quality of the standby link; and

a first transmitting module 530, configured to transmit the ACM switching instruction to a transmitting device, so as to instruct the transmitting device to perform an ACM switching.

The microwave device in the embodiment is applied in a microwave communication system configured with an ACM function and an HSM function.

The microwave device in the embodiment may be the receiving device of the active link, and at this time, the obtaining module 510 in the microwave device receives the signal quality information of the standby link from the microwave device of the standby link; and at this time, the microwave device further includes a second transmitting module 540, which is configured to transmit the signal quality information of the link of the microwave device to the microwave device of the standby link. The transmission may be in the manner of a connected hardware or a software protocol, where the transmitting through the hardware can meet the real-time requirement of the system.

The microwave device in this embodiment may be the receiving device of the standby link, and at this time, the obtaining module 510 in the microwave device may receive the signal quality information of the active link from the microwave device of the active link. At this time, the microwave device further includes a third transmitting module, which is configured to transmit the signal quality information of the link of the microwave device to the microwave device of the active link. The transmission may be in the manner of a connected hardware or a software protocol.

In a word, if the microwave device in this embodiment is a receiving device, the signal quality information of a redundant link may be received from a microwave device of the redundant link, and the receiving manner may be a connected hardware or a software protocol. In the embodiments of the present invention, the term “redundant link” refers to a backup link relative to the current link. For example, if the microwave device of the embodiment is in the standby link, its redundant link is the active link.

The generating module 520 may include:

a judging unit, configured to judge whether the better one between the signal quality of the active link and the signal quality of the standby link obtained this time is the same as the better one between the signal quality of the active link and the signal quality of the standby link obtained last time, and trigger a generating unit to generate an ACM switching instruction if they are different; and

the generating unit, configured to generate the ACM switching instruction.

Corresponding to the embodiment shown in FIG. 4, the first transmitting module 530 transmits the ACM switching instruction generated by the generating module to a transmitting device of the active link, so that the transmitting device of the active link performs an ACM switching according to the ACM switching instruction. The ACM switching instruction in this embodiment is generated according to the better one between the signal quality of the active link and the signal quality of the standby link, so the service bandwidth of the system is determined by the better one between the signal quality of the active link and the signal quality of the standby link. Therefore, the available bandwidth of the link can be fully utilized and the transmission efficiency of the system is improved.

Referring to FIG. 6, an embodiment of a microwave communication system of the present invention includes:

a receiving device 610, configured to obtain the signal quality of an active link and the signal quality of a standby link, generate an ACM switching instruction according to the better one between the signal quality of the active link and the signal quality of the standby link, and transmit the ACM switching instruction to a transmitting device in order to instruct a transmitting device 620 to perform an ACM switching; and

a transmitting device 620, configured to receive the ACM switching instruction from the receiving device 610, and perform an ACM switching according to the ACM switching instruction.

The microwave communication system in this embodiment is configured with an ACM function and an HSM function. After the receiving device 610 transmits the generated ACM switching instruction to a transmitting device of the active link, the transmitting device of the active link switches the service bandwidth according to the ACM switching instruction. That is to say, the service bandwidth is changed to the service bandwidth corresponding to a coding manner and a modulation mode in the ACM switching instruction, and the services after the switching and the ACM switching instruction are transmitted to a transmitting device of the standby link, thus ensuring the consistency of the active link and the standby link. Besides, the transmitting device of the standby link, following the transmitting device of the active link, switches the coding manner and the modulation mode according to the ACM switching instruction.

At the same time, in order to realize the HSM function, at the receiving end, the receiving devices of the active link and the standby link transmit the services to each other, and the receiving device of the active link selects a service with better quality from the two services to output.

In this embodiment, an ACM switching instruction is generated according to the better one between the signal quality of the active link and the signal quality of the standby link, so the service bandwidth of the system is determined by the better one between the signal quality of the active link and the signal quality of the standby link. Therefore, when the signal quality of the standby link is better than the signal quality of the active link, the service bandwidth of the system is determined by the better signal quality of the standby link. Compared with the determining by the poor signal quality of the active link in the prior art, the embodiment can fully utilize the available bandwidth of the link, thus improving the transmission efficiency of the system.

Persons of ordinary skills in the art may understand that all or part of the steps of the method according to the embodiments of the present invention may be implemented by a program instructing relevant hardware. The program may be stored in a computer readable storage medium, which may be a Read-Only Memory (ROM), a Random Access Memory (RAM), a magnetic disk or an optical disk.

A microwave device, a system and a method for instructing an ACM switching according to the embodiment of the present invention are introduced in detail above. The principle and implementation of the embodiment of the present invention are described herein through specific embodiments, and the description of the embodiments is merely intended to make the method and core idea of the present invention comprehensible. Persons having ordinary skills in the art can make variations and modifications to the embodiments in terms of the specific implementations and application scopes according to the ideas of the present invention. Therefore, the specification shall not be construed as limitations to the specification.

1. A method for instructing an Adaptive Code and Modulation (ACM) switching in Hitless Switching Mode (HSM) systems, comprising:
obtaining signal quality of an active link and signal quality of a standby link;
determining the better signal quality between the signal quality of the active link and the signal quality of the standby link;
generating an ACM switching instruction according to the better signal quality; and
transmitting the ACM switching instruction to a transmitting device, to instruct the transmitting device to perform an ACM switching.

2. The method according to claim 1, wherein the obtaining the signal quality of the active link and the signal quality of the standby link comprises: obtaining, by a receiving device of the active link, the signal quality of the active link and the signal quality of the standby link;
the generating an ACM switching instruction according to the better signal quality comprises: generating, by the receiving device of the active link, the ACM switching instruction according to the better signal quality; and
the transmitting the ACM switching instruction to the transmitting device comprises: transmitting, by the receiving device of the active link, the ACM switching instruction to a transmitting device of the active link.

3. The method according to claim 2, wherein the obtaining, by a receiving device of the active link, the signal quality of the standby link comprising: receiving, by the receiving device of the active link, the signal quality information of the standby link from a receiving device of the standby link through a hardware or a software protocol.

4. The method according to claim 2, further comprising: transmitting, by the receiving device of the active link, the signal quality information of the active link to the receiving device of the standby link.

5. The method according to claim 1, wherein the signal quality of the active link is a Mean Square Error (MSE) between an actual signal of the active link and a standard signal of the active link; and the signal quality of the standby link is an MSE between an actual signal of the standby link and a standard signal of the standby link.

6. A microwave device for instructing an Adaptive Code and Modulation (ACM) switching in Hitless Switching Mode (HSM) systems, comprising:
an obtaining module, configured to obtain signal quality of an active link and signal quality of a standby link;
a generating module, configured to generate an Adaptive Code and Modulation (ACM) switching instruction according to the better signal quality between the signal quality of the active link and the signal quality of the standby link; and
a first transmitting module, configured to transmit the ACM switching instruction to a transmitting device, to instruct the transmitting device to perform an ACM switching.

7. The microwave device according to claim 6, wherein the microwave device is a receiving device of the active link, and the obtaining module receives the signal quality of the standby link from a receiving device of the standby link through a hardware or a software protocol.

8. The microwave device according to claim 7, further comprising:
a second transmitting module, configured to transmit signal quality information of the link of the microwave device to the receiving device of the standby link.

9. The microwave device according to claim 6, wherein the generating module comprises:
a determine unit, configured to determine whether the better signal quality obtained this time is the same as the better signal quality obtained last time, and trigger a generating unit to generate the ACM switching instruction if the better signal quality obtained this time is different from the better signal quality obtained last time; and
the generating unit, configured to generate the ACM switching instruction.

10. A Hitless Switching Mode (HSM) microwave communication system for instructing an Adaptive Code and Modulation (ACM) switching, comprising:
a receiving device, configured to obtain signal quality of an active link and signal quality of a standby link, generate an Adaptive Code and Modulation (ACM) switching instruction according to the better signal quality between the signal quality of the active link and the signal quality of the standby link, and transmit the ACM switching instruction to a transmitting device, to instruct the transmitting device to perform an ACM switching; and
a transmitting device, configured to receive the ACM switching instruction from the receiving device, and perform an ACM switching on the services according to the ACM switching instruction.
